(19) United States
(12) Patent Application Publication
(10) Pub. No.: US 2026/0294724 A1
(43) Pub. Date: Oct. 1, 2026

(54) CASKET INCLUDING EXPANDED INTERIOR WIDTH

(71) Applicant: Batesville Services, LLC, Batesville, IN (US)

(72) Inventor: Gregory William Wray, Guilford, IN (US)

(73) Assignee: Batesville Services, LLC, Batesville, IN (US)

(21) Appl. No.: 19/577,877

(22) Filed: Mar. 25, 2026

Related U.S. Application Data
(60) Provisional application No. 63/779,420, filed on Mar. 28, 2025.

(51) Int. Cl. A61G 17/04; A61G 17/02

(52) U.S. Cl. CPC A61G 17/041; A61G 17/028

(57) ABSTRACT

A casket including a body including a pair of side walls defining an open interior, each of the pair of side walls having an inner surface defining an inner recess and an inner protrusion extending along a length of the pair of side walls, the inner recess defining an outer protrusion defined on an outer surface of each of the pair of side walls, the inner protrusion defining an outer recess defined on the outer surface of each of the pair of side walls, a lid rotatably coupled to one of pair of side walls, and a handle extending from the outer surface of one of the pair of side walls and rotatable between a deployed position and a stowed position, the handle received within the outer recess of one of the pair of side walls when in the stowed position.

This application claims the benefit of U.S. Provisional Application Serial Number 63/779,420, filed Mar. 28, 2025, entitled Casket Including Expanded Interior Width, which is hereby incorporated by reference in its entirety.

### TECHNICAL FIELD

Embodiments of the present disclosure generally relate to caskets, and more specifically relate to caskets with an expanded interior width.

### BACKGROUND

Standard caskets have an interior width of 27 inches and an exterior width of 29.5 inches. Caskets also typically include a lip at an edge of a lid of the casket in order to latch the lid securely to a body of the casket. The standard exterior width of the casket enables the casket to fit into a standard burial vault while maintaining a lip at an edge of the lid of the casket.

However, there is a desire to increase the interior width of a casket while maintaining the outer width and a lip at an edge of a lid of the casket. Maintaining the exterior width may ensure the casket fits into a standard burial vault while providing more space within the interior of the casket.

### SUMMARY

Embodiments of the present disclosure are directed to caskets including side walls defining recesses and protrusions to provide an increased interior width while maintaining a typical maximum exterior width. In particular, embodiments are directed to a casket that includes a pair of side walls that each include a protrusion and a recess formed between the protrusions and a bottom wall of the body.

According to some embodiments, the casket described in this disclosure includes a body including a pair of side walls, a pair of end walls extending between the pair of side walls, and a bottom wall cooperating to define an open interior, each of the pair of side walls having an inner surface defining an inner recess and an inner protrusion extending along a length of the pair of side walls, the inner recess defining an outer protrusion defined on an outer surface of each of the pair of side walls, the inner protrusion defining an outer recess defined on the outer surface of each of the pair of side walls; a lid rotatably coupled to one of pair of side walls; and a handle extending from the outer surface of one of the pair of side walls and rotatable between a deployed position and a stowed position, the handle received within the outer recess of one of the pair of side walls when in the stowed position.

According to other embodiments, the casket includes a body including a pair of side walls, a pair of end walls extending between the pair of side walls, and a bottom wall cooperating to define an open interior, each of the pair of side walls having an inner surface defining an inner recess and an inner protrusion extending along a length of the pair of side walls, the inner recess defining an outer protrusion defined on an outer surface of each of the pair of side walls, the inner protrusion defining an outer recess defined on the outer surface of each of the pair of side walls; a lid rotatably coupled to one of the pair of side walls; a handle extending from the outer surface of one of the pair of side walls; and a first inner width defined between the inner protrusions of the pair of side walls and a second inner width greater than the first inner width defined between the pair of inner recesses of the pair of side walls.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a perspective view of a casket including a body and a lid in an open position, according to embodiments provided herein;

FIG. 2 depicts a side view of the casket with the lid in a closed position, according to embodiments provided herein;

FIG. 3 depicts a perspective view of the body of the casket, according to embodiments provided herein;

FIG. 4 depicts a side view of the body of the casket, according to embodiments provided herein;

FIG. 5 depicts a cross-sectional view of the body of the casket taken along line 5-5 of FIG. 4, according to embodiments provided herein; and

FIG. 6 depicts a cross-sectional view of the casket taken along line 6-6 of FIG. 4, according to embodiments provided herein.

### DETAILED DESCRIPTION

The present disclosure is directed to a casket having an expanded interior width. In particular, embodiments are directed to a casket comprising recesses and protrusions extending in an outward direction for increasing the interior width of a body of the casket. The casket may further include recesses and protrusions extending in an inward direction for maintaining an exterior width of the body. Embodiments of the casket incorporating the same will be described in more detail, below.

As previously discussed, standard caskets have an interior width of 27 inches and an exterior width of 29.5 inches which enables the casket to fit into a standard burial vault. Standard caskets also typically include a lip at an edge of a lid of the casket in order to latch the lid securely to a body of the casket. However, there is a desire to increase the interior width of a casket to accommodate a deceased whom may require more space. This may be challenging to achieve while also ensuring that the casket may continue to fit into a standard burial vault and include a lip to securely latch the lid to the casket.

Accordingly, there is an ongoing need for of a casket including an expanded interior width that maintains the exterior width and a lip at the edge of the lid. The present disclosure is directed to a casket that utilizes side walls defining recesses and protrusions to provide an increased interior width without the need for increasing the exterior width or foregoing the lip. The subject matter of the present disclosure meets this need by including a pair of inner recesses and a pair of outer protrusions, where the pair of inner recesses may provide additional space in an open interior of the casket by increasing the interior width of the casket. The pair of outer protrusions may maintain a standard exterior width by an outer recess that may receive a handle of the casket and may allow the handle to not extend past the standard exterior width. The handle may then not increase an overall exterior width of the casket to ensure the casket fits into a standard burial vault. The casket may also form a gap between the lip of the lid and the outer protrusions which may allow a user to position their fingers within the gap and lift the lid.

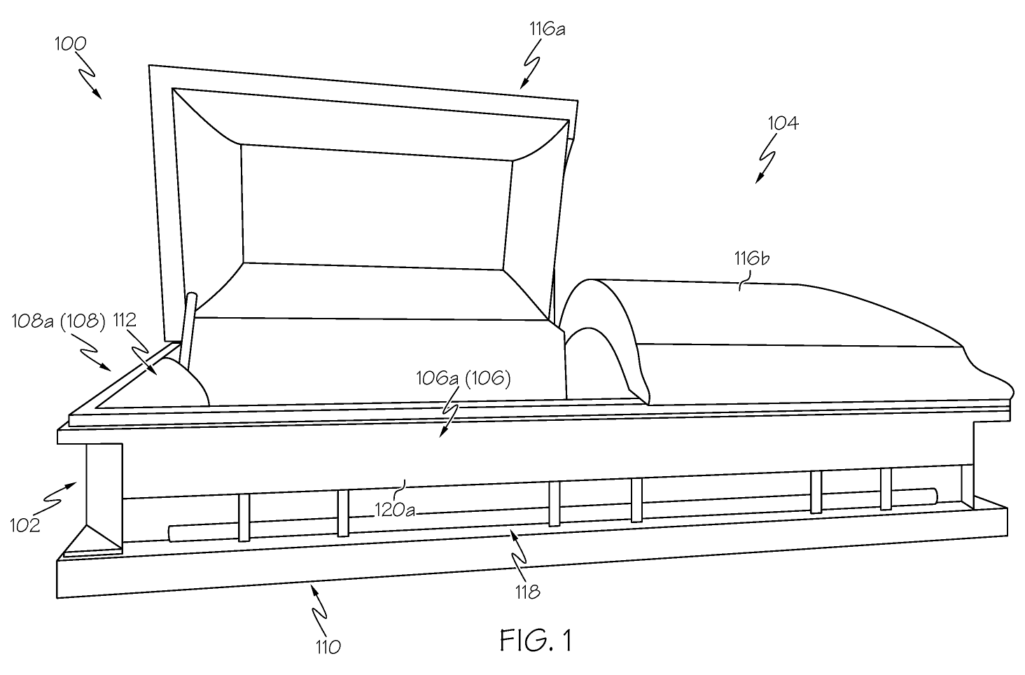

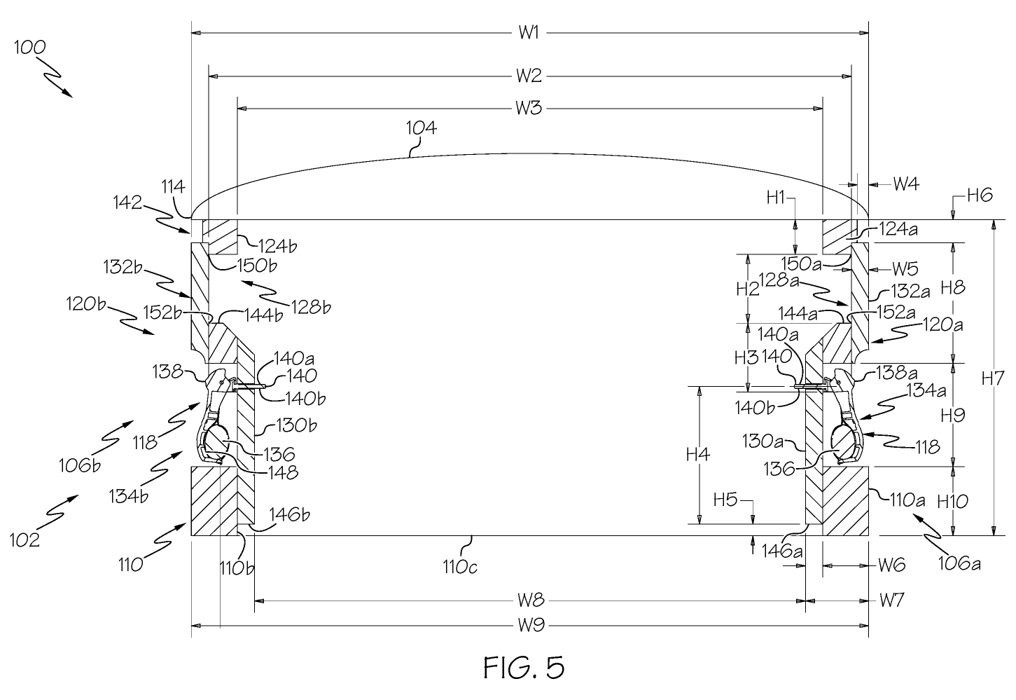

Referring now to the drawings, FIG. 1 depicts a perspective view of a casket 100 in an open position according to embodiments provided herein. As illustrated, the casket 100 includes a body 102 and a lid 104. The body 102 may be configured to accommodate a deceased. The body 102 includes a pair of side walls 106a, 106b (106b not depicted in FIG. 1), a pair of end walls 108a, 108b (108b not depicted in FIG. 1), and a bottom wall 110. The pair of end walls 108a, 108b extend between the pair of side walls 106a, 106b. The bottom wall 110 extends between the pair of side walls 106a, 106b and the pair of end walls 108a, 108b to define an open interior 112. As such, when a deceased is positioned inside the cavity of the body 102, the deceased may rest against the bottom wall 110 of the open interior 112. The lid 104 includes a lip 114 and, in embodiments, a pair of upper panels 116a, 116b. The lip 114 is formed along at least opposite side edges of the lid 104. As illustrated in the example of FIG. 1, the upper panels 116a, 116b may fit within the cavity defined by the pair of side walls 106a, 106b, the pair of end walls 108a, 108b, and the bottom wall 110. In such an embodiment, the upper panels 116a, 116b may contact an inner surface of the pair of side walls 106 and/or the pair of end walls 108 to keep the upper panels 116a, 116b in place. Although the lid 104 is depicted as including a pair of upper panels 116a, 116b, it should be appreciated that the lid 104 may include only a single panel, such as a full length lid, or more than two panels. It should also be appreciated that while FIG. 1 illustrates one of the pair of upper panels 116a, 116b of the lid 104 as being open, this is merely one example, some embodiments include both of the pair of upper panels 116a, 116b as being open. Still referring to FIG. 1, the lid 104 is rotatably coupled to one of the pair of side walls 106a, 106b and is positionable between an open position and a closed position. Additionally, the upper panels 116a, 116b of the lid 104 may each independently be positionable between the open position and the closed position. As shown in FIG. 1, the upper panel 116a is in the open position and the upper panel 116b is in the closed position so that the open interior 112 of the body 102 may be shown. In embodiments, the upper panels 116a, 116b contact the pair of side walls 106a, 106b and/or the end walls 108a, 108b to support the upper panel 116b when in the closed position. As will be understood, while FIG. 1 illustrates the lid 104 as being truncated, this is merely one example to show the interior of the body 102. Some embodiments include a full length lid 104. Additionally, the body 102 further includes a pair of handles 118, although only one of the handles 118 is illustrated. As will be discussed in greater detail below, the handle 118 extends along the entire length of an outer surface 120a of the side wall 106a. The handle 118 is rotatably mounted and coupled to the outer surface 120a of the side wall 106a. The other handle 118 extends along the entire length of the side wall 106b (FIG. 5). The pair of handles 118 may be utilized to aid a human in handling the casket 100.

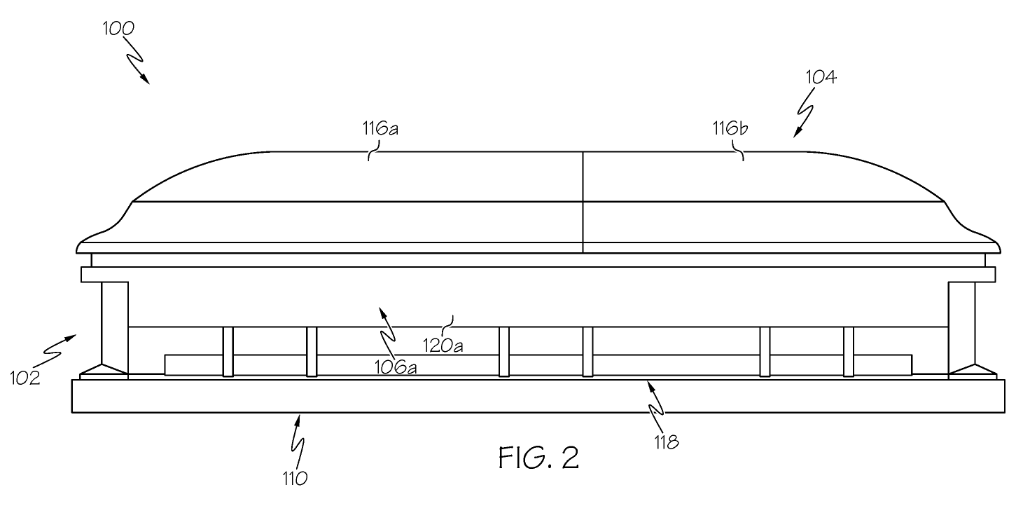

Referring now to FIG. 2, a side view of the casket 100 is shown with the lid 104 in the closed position. As mentioned above, the lid 104 may include the lip 114 and the pair of upper panels 116a, 116b. Additionally, the lid 104 may be positioned within the cavity defined by the the pair of side walls 106a, 106b, the pair of end walls 108a, 108b, and the bottom wall 110.As such, when a deceased is positioned inside the cavity of the body 102, the deceased may rest against the bottom wall 110 of a lower end of the open interior 112. As illustrated, when the casket 100 is in the closed position, the lid 104 covers an upper end of the open interior 112. As mentioned above, the handle 118 extends from and is rotatably coupled to the side wall 106a. The handle 118 is rotatable between a deployed position and a stowed position. In such embodiments, the handle 118 is rotated against the side wall 106a. As will be understood, while FIG. 2 illustrates both of the pair of upper panels 116a, 116b of the lid 104 as being closed, this is merely one example, some embodiments include one of the pair of upper panels 116a, 116b as being closed and one of the pair of upper panels 116a, 116b as being open, such as is depicted in FIG. 1.

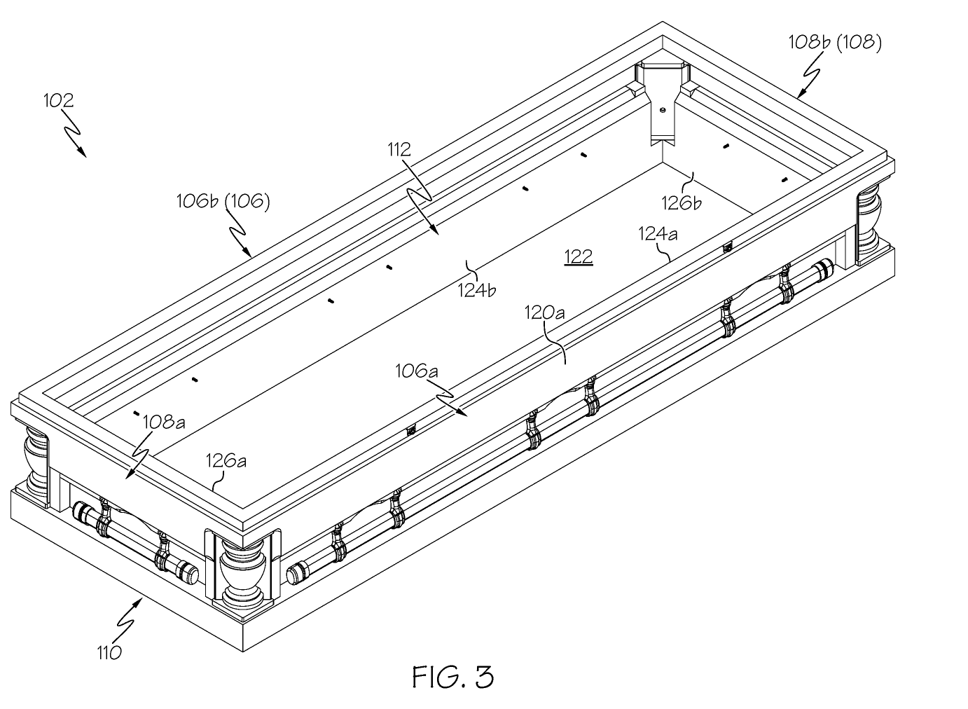

Referring now to FIG. 3, a perspective view of the body 102 of the casket 100 is depicted without the lid 104 to better illustrate the open interior 112 of the body 102. The bottom wall 110 includes a bottom surface 122 facing the open interior 112. As illustrated, the bottom surface 122 of the bottom wall 110 is formed as a one-piece monolithic component. However, it should be appreciated that the bottom surface 122 may be formed as a plurality of individual segments. The pair of side walls 106a, 106b may include respective inner surfaces 124a, 124b and outer surfaces 120a, 120b (120b not depicted in FIG. 3). Similarly, the pair of end walls 108a, 108b include respective inner surfaces 126a, 126b. The inner surfaces 124a, 124b of the pair of side walls 106a, 106b extend between and contact the inner surfaces 126a, 126b of the pair of end walls 108a, 108b, as well as the bottom surface 122 of the bottom wall 110. The inner surfaces 124a, 124b of the pair of side walls 106a, 106b and the inner surfaces 126a, 126b of the pair of end walls 108a, 108b extend upwardly from the bottom surface 122 of the bottom wall 110. Accordingly, the inner surfaces 124a, 124b of the side walls 106a, 106b, the inner surfaces 126a, 126b of the end walls 108a, 108b, and the bottom surface 122 of the bottom wall 110 cooperate to define the open interior 112.

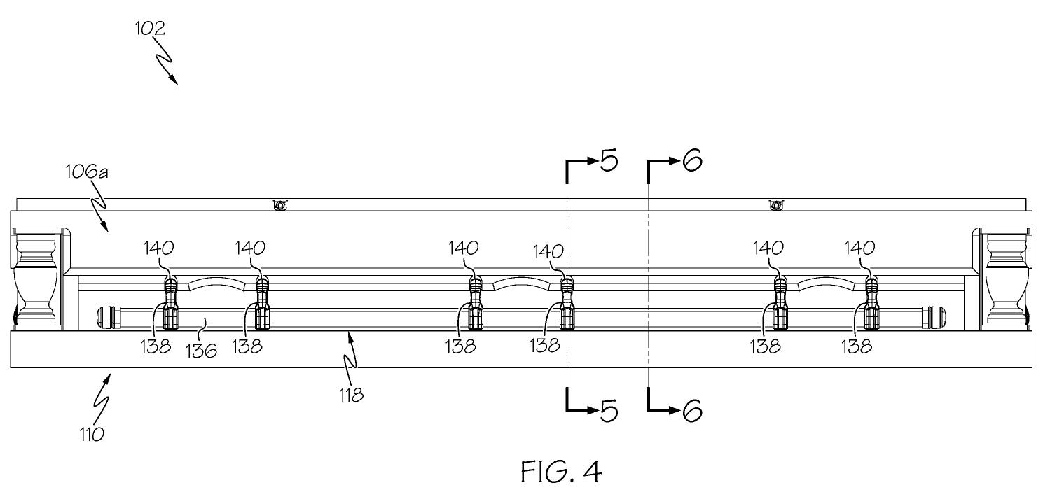

Referring now to FIG. 4, a side view of the body 102 of the casket 100 is depicted. In FIG. 4, cross-sectional line 5-5 is drawn along a first portion of the handle 118 and cross-sectional line 6-6 is drawn along a second portion of the handle 118 at a different longitudinal location between the pair of end walls 108a, 108b. As illustrated, the casket 100 is in a closed position. As mentioned above, the casket 100 includes a pair of handles 118 that extend from the side walls 106a, 106b. Each handle 118 includes a bar 136, a plurality of mounting brackets 138, and a plurality of fasteners 140. The plurality of mounting brackets 138 of the handle 118 extending along the side wall 106a are rotatably mounted to the side wall 106a. In embodiments, the bar 136 extends through the plurality of mounting brackets 138 along the length of the side wall 106a. In other embodiments, as described in more detail herein, the bar 136 is mounted to an end of the mounting brackets 138 rather than extending through the mounting brackets 138.

Referring now to FIG. 5, a cross-sectional view of the casket 100 taken along line 5-5 of FIG. 4 is depicted. As illustrated, each of the pair of side walls 106a, 106b include the inner surfaces 124a, 124b that define inner recesses 128a, 128b and inner protrusions 130a, 130b extending along the length of the pair of side walls 106a, 106b. The inner recesses 128a, 128b define outer protrusions 132a, 132b formed on the outer surfaces 120a, 120b of each of the pair of side walls 106a, 106b. The inner protrusions 130a, 130b define outer recesses 134a, 134b formed on the outer surfaces 120a, 120b of each of the pair of side walls 106a, 106b.

The inner protrusions 130a, 130b extend in a vertical direction between the bottom wall 110 and the inner recesses 128a, 128b. The inner recesses 128a, 128b extend in the vertical direction between the inner protrusions 130a, 130b and the lid 104.

The outer recesses 134a, 134b extend in the vertical direction between the bottom wall 110 and the outer protrusions 132a, 132b. The outer protrusions 132a, 132b extend in the vertical direction between the outer recesses 134a, 134b and the lid 104.

In embodiments, a gap 142 is formed between the lid 104 and the outer protrusions 132a, 132b. More particularly, the gap 142 is formed between the lip 114 of the lid 104 and the outer protrusions 132a, 132b. Accordingly, in use, a user may position their fingers within the gap 142 at one of the side walls 106a, 106a and lift the lid 104. Alternatively, if the gap 142 were not to be provided, it would be difficult for someone to grip and lift the lid 104. As described herein, the lip 114 extends along at least opposite side edges of the lid 104.

Still referring to FIG. 5, the handle 118 extends from the outer surface 120a of the side wall 106a. As mentioned above, the handle 118 is rotatable between a stowed position, as shown in FIG. 5, and a deployed position. While in a stowed position, the handle 118 is received within the outer recess 134a. As mentioned above, the handle 118 includes a bar 136, a plurality of mounting brackets 138, and a plurality of fasteners 140. In embodiments, the bar 136 is received within the pair of outer recesses 134a, 134b. An opening 148 is formed in each of the plurality of mounting brackets 138 opposite the side wall 106a. The bar 136 extends through the opening 148 and is secured to the mounting bracket 138 through any suitable means, such as, by a thread or by a fastener. The plurality of fasteners 140 extend through the side wall 106a within the outer recess 134a and into the plurality of mounting brackets 138 to fix the handle 118 to the outer surface 120a of the side wall 106a.

Still referring to FIG. 5, a width W1 is defined between the pair of outer surfaces 120a, 120b of the pair of side walls 106a, 106b at the pair of outer protrusions 132a, 132b. In embodiments, the width W1 is greater than or equal to 29 inches (in) and less than or equal to 30 in. In embodiments, the width W1 is greater than or equal to 29.25 in and less than or equal to 29.75 in. In embodiments, the width W1 is 29.5 in. It should be appreciated that the width W1 is less than or equal to a width between the lip 114 at opposite side edges of the lid 104. Accordingly, the widest point of the casket 100 is defined by the lid 104.

A width W2 is defined between the pair of inner surfaces 124a, 124b of the pair of side walls 106a, 106b at the pair of inner recesses 128a, 128b. In embodiments, the width W2 is greater than or equal to 27.5 in and less than or equal to 28.5 in. In embodiments, the width W2 is greater than or equal to 27.75 in and less than or equal to 28.25 in. In embodiments, the width W2 is 28 in.

A width W3 is defined between the inner surfaces 124a, 124b of the pair of side walls 106a, 106b at the pair of inner protrusions 130a, 130b. In embodiments, the width W3 is greater than or equal to 25 in and less than or equal to 26 in. In embodiments, the width W3 is greater than or equal to 25.25 in and less than or equal to 25.75 in. In embodiments, the width W3 is 25.5 in. In embodiments, the width W2 is greater than the width W3.

A width W4 is defined by the difference between the pair of outer protrusions 132a, 132b and pair of outer surfaces 120a, 120b of the pair of side walls 106a, 106b at the gap 142. In embodiments, the width W4 is greater than or equal to 0.1 in and less than or equal to 1 in. In embodiments, the width W4 is greater than or equal to 0.25 in and less than or equal to 0.75 in. In embodiments, the width W4 is 0.5 in.

A width W5 is defined by a distance between the pair of inner surfaces 124a, 124b of the pair of side walls 106a, 106b and the pair of outer surfaces 120a, 120b of the pair of side walls 106a, 106b at the pair of outer protrusions 132a, 132b. In embodiments, the width W5 is greater than or equal to 0.25 in and less than or equal to 1.25 in. In embodiments, the width W5 is greater than or equal to 0.5 in and less than or equal to 1 in. In embodiments, the width W5 is 0.75 in.

A width W6 is defined between an outer surface 110a and an inner surface 110b of the bottom wall 110. In embodiments, W6 is greater than or equal to 1.5 in and less than or equal to 2.5 in. In embodiments, W6 is greater than or equal to 1.75 in and less than or equal to 2.25 in. In embodiments, W6 is 2 in.

A width W7 is defined between the pair of inner surfaces 124a, 124b of the pair of side walls 106a, 106b at the pair of inner protrusions 130a, 130b and the outer surface 110a of the bottom wall 110. In embodiments, the width W7 is greater than or equal to 2.25 in and less than or equal to 3.25 in. In embodiments, the width W7 is greater than or equal to 2.5 in and less than or equal to 3 in. In embodiments, the width W7 is 2.75 in.

A width W8 is defined between the pair of inner surfaces 124a, 124b of the pair of side walls 106a, 106b at the pair of inner protrusions 130a, 130b. In embodiments, the width W8 is greater than or equal to 23.5 in and less than or equal to 24.5 in. In embodiments, the width W8 is greater than or equal to 23.75 in and less than or equal to 24.25 in. In embodiments, the width W8 is 24 in.

A width W9 is defined between the pair of outer surfaces 120a, 120b of the pair of side walls 106a, 106b at the bottom wall 110. In embodiments, the width W9 is greater than or equal to 29 in and less than or equal to 30 in. In embodiments, the width W9 is greater than or equal to 29.25 in and less than or equal to 29.75 in. In embodiments, the width W9 is 29.5 in. In embodiments, W1 is greater than or equal to W9.

In embodiments, the pair of inner recesses 128a, 128b and the pair of outer protrusions 132a, 132b provide an increased amount of space as compared to a casket having a typical interior width. Accordingly, the width W2 is larger than the width W3, whereas the width W3 depicts an interior width of a typical casket. At the same time, the casket 100 allows for an expanded interior width such as, depicted here by the width W2, while maintaining a standard exterior width, depicted here by the width W1. Stated another way, the pair of inner recesses 128a, 128b provide additional space in the open interior 112 of the casket 100, thereby increasing the interior width of the casket 100. More particularly, the interior width of the casket 100 is increased by a difference between the width W2 and the width W3. At the same time, the pair of outer protrusions 132a, 132b maintain a standard exterior width, depicted here by the width W1. This is due to the handle 118 being received within the outer recess 134a, whereby the outer recess 134a is between the width W1 and the width W3 allowing the handle 118 to not extend past the width W1. Thus, the handle 118 does not increase an overall exterior width of the casket 100.

Still referring to FIG. 5, a height H1 is defined between the lid 104 and the pair of inner recesses 128a, 128b at the pair of inner surfaces 124a, 124b of the pair of side walls 106a, 106b. In embodiments, the height H1 is greater than or equal to 1 in and less than or equal to 2 in. In embodiments, the height H1 is greater than or equal to 1.25 in and less than or equal to 1.75 in. In embodiments, the height H1 is 1.5 in.

A height H2 is defined between a top 150a, 150b and a bottom 152a, 152b of the pair of inner recesses 128a, 128b. In embodiments, the height H2 is greater than or equal to 2.5 in and less than or equal to 3.5 in. In embodiments, the height H2 is greater than or equal to 2.75 in and less than or equal to 3.25 in. In embodiments, the height H2 is 3 in.

A height H3 is defined between a bottom 144a, 144b of the inner recesses 128a, 128b and a bottom 140b of the plurality of the fasteners 140. In embodiments, the height H3 is greater than or equal to 2.5 in and less than or equal to 3.5 in. In embodiments, the height H3 is greater than or equal to 2.75 in and less than or equal to 3.25 in. In embodiments, the height H3 is 3 in.

A height H4 is defined between a top 140a of the plurality of fasteners 140 and a bottom 146a, 146b of the pair of inner protrusions 130a, 130b. In embodiments, the height H4 is greater than or equal to 5.5 in and less than or equal to 6.5 in. In embodiments, the height H4 is greater than or equal to 5.75 in and less than or equal to 6.25 in. In embodiments, the height H4 is 6 in.

A height H5 is defined between the bottom 146a, 146b of the pair of inner protrusions 130a, 130b and a bottom surface 110c of the bottom wall 110. In embodiments, the height H5 is greater than or equal to 0.25 in and less than or equal to 1.25 in. In embodiments, the height H5 is greater than or equal to 0.5 in and less than or equal to 1 in. In embodiments, the height H5 is 0.75 in.

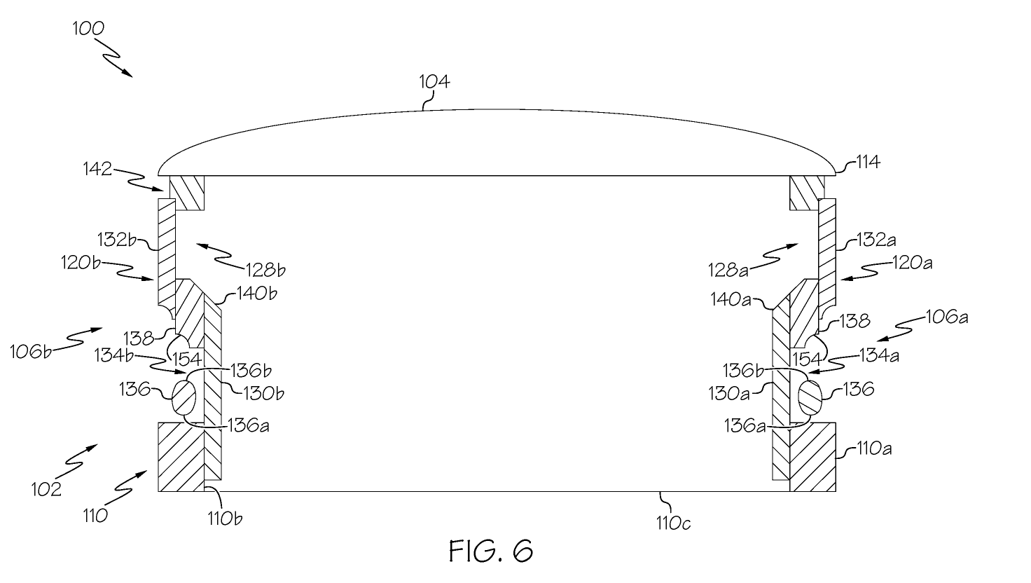

FIG. 6 depicts a cross-sectional view of the casket 100 taken along line 6-6 of FIG. 5. As illustrated, the bar 136 is shown extending through the outer recess 134a when the handle 118 is in the stowed position. The bar 136 has a lower end 136a and an upper end 136b, where the lower end 136a is below the upper end 136b. As seen in FIG. 6, the body 102 further includes a trim 154 within the outer recesses 134a, 134b below the plurality of fasteners 140.

From the above, it is to be appreciated that defined herein is a casket that includes a body and a lid, the body including a pair of side walls, a pair of end walls extending between the pair of side walls, and a bottom wall cooperating to define an open interior, each of the pair of side walls having an inner surface defining an inner recess and an inner protrusion extending along a length of the pair of side walls, the inner recess defining an outer protrusion defined on an outer surface of each of the pair of side walls, the inner protrusion defining an outer recess defined on the outer surface of each of the pair of side walls; the lid rotatably coupled to one of the pair of side walls; and a pair of handles extending from the outer surface of the pair of side walls and rotatable between a deployed position and a stowed position, the pair of handles received within the inner recesses when in the stowed position.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

1. A casket comprising:
a body including a pair of side walls, a pair of end walls extending between the pair of side walls, and a bottom wall cooperating to define an open interior, each of the pair of side walls having an inner surface defining an inner recess and an inner protrusion extending along a length of the pair of side walls, the inner recess defining an outer protrusion defined on an outer surface of each of the pair of side walls, the inner protrusion defining an outer recess defined on the outer surface of each of the pair of side walls;
a lid rotatably coupled to one of pair of side walls; and
a handle extending from the outer surface of one of the pair of side walls and rotatable between a deployed position and a stowed position, the handle received within the outer recess of one of the pair of side walls when in the stowed position.

2. The casket of claim 1, wherein a width defined between the inner recesses of the pair of side walls is greater than a width defined between the inner protrusions of the pair of side walls.

3. The casket of claim 1, wherein the inner protrusions are provided between the inner recesses and the bottom wall.

4. The casket of claim 2, wherein the width defined between the inner protrusions is greater than or equal to 23 inches and less than or equal to 25 inches.

5. The casket of claim 4, wherein the width defined between the inner recesses is greater than or equal to 27 inches and less than or equal to 29 inches.

6. The casket of claim 5, wherein a width defined between opposite side edges of the lid is equal to or greater than a width defined between outer protrusions of the pair of side walls.

7. The casket of claim 6, wherein the width defined between opposite side edges of the lid is equal to or greater than 29 inches and less than or equal to 30 inches.

8. The casket of claim 7, wherein a width is defined between opposite sides of a lip formed at opposite side edges of the lid, wherein a gap is formed between the lip and an upper end of the pair of outer protrusions.

9. The casket of claim 8, wherein the width defined between opposite sides of the lip is equal to or greater than 29 inches and less than or equal to 30 inches.

10. A casket comprising:
a body including a pair of side walls, a pair of end walls extending between the pair of side walls, and a bottom wall cooperating to define an open interior, each of the pair of side walls having an inner surface defining an inner recess and an inner protrusion extending along a length of the pair of side walls, the inner recess defining an outer protrusion defined on an outer surface of each of the pair of side walls, the inner protrusion defining an outer recess defined on the outer surface of each of the pair of side walls;
a lid rotatably coupled to one of the pair of side walls;
a handle extending from the outer surface of one of the pair of side walls; and
a width defined between the pair of inner recesses of the pair of side walls is greater than a width defined between the inner protrusions of the pair of side walls.

11. The casket of claim 10, wherein the inner protrusions are provided between the inner recesses and the bottom wall.

12. The casket of claim 10, wherein the handle is rotatable between a deployed position and a stowed position, the handle is received within one of the pair of outer recesses when in the stowed position.

13. The casket of claim 12, wherein the handle is received within one of the outer recesses when in the stowed position.

14. The casket of claim 13, wherein the width defined between the inner protrusions is greater than or equal to 23 inches and less than or equal to 25 inches.

15. The casket of claim 13, wherein the width defined between the inner recesses is greater than or equal to 27 inches and less than or equal to 29 inches.

16. The casket of claim 10, wherein a width defined between opposite side edges of the lid is equal to or greater than a width defined between the outer protrusions of the pair of side walls.

17. The casket of claim 16, wherein the width defined between opposite side edges of the lid is equal to or greater than 29 inches and less than or equal to 30 inches.

18. The casket of claim 17, wherein the width defined between the outer protrusions is equal to or greater than 29 inches and less than or equal to 30 inches.

19. The casket of claim 10, further comprising a lid rotatably coupled to one of pair of side walls, wherein the lid includes a lip formed at opposite side edges of the lid and defines a width equal to or greater than the width defined between the outer protrusions.

20. The casket of claim 19, wherein a gap is formed between the lip and an upper surface of the pair of outer protrusions.
